(19) United States
(12) Patent Application Publication
(10) Pub. No.: US 2018/0203287 A1
(43) Pub. Date: Jul. 19, 2018

(54) DISPLAY SUBSTRATE, DISPLAY PANEL, DISPLAY DEVICE AND METHOD FOR PRODUCING THE DISPLAY SUBSTRATE

(71) Applicant: BOE TECHNOLOGY GROUP CO., LTD., Beijing (CN)

(72) Inventors: Xiaolin Wang, Beijing (CN); Yuanbo Zhang, Beijing (CN)

(21) Appl. No.: 15/566,693

(22) PCT Filed: Apr. 17, 2017
(86) PCT No.: PCT/CN2017/080772

§ 371 Date: Oct. 13, 2017

(30) Foreign Application Priority Data
Apr. 22, 2016 (CN) 201610258385.0

(51) Int. Cl. G02F 1/1335; G02F 1/133

(52) U.S. Cl. CPC G02F 1/133512; G09G 2310/0264; G02F 1/13306

(57) ABSTRACT

The present disclosure provides a display substrate, a display panel, a display device and a method for producing the display substrate. The display substrate includes a base substrate and a black matrix formed on the base substrate, the black matrix having physical portions and a first gap region between the physical portions, the first gap region being aligned with a clock signal line of a gate driving circuit on an opposite substrate, wherein at least one layer of first color resist is provided in the first gap region.

### CROSS-REFERENCE TO RELATED APPLICATION

This application claims benefit of the Chinese Patent Application No. 201610258385.0, filed with SIPO on Apr. 22, 2016, which is incorporated herein by reference in its entirety.

### BACKGROUND OF THE DISCLOSURE

### Field of the Disclosure

The present disclosure relates to the technical field of display, and in particular, to a display substrate, a display panel, a display device and a method for producing the display substrate.

### Description of the Related Art

In a flat panel display device, a thin film transistor liquid crystal display (TFT-LCD) has advantages such as small volume, low power consumption, relatively low manufacturing cost and no radiation. It is predominant in current markets of the flat panel display device.

The TFT-LCD includes a display panel and a driving circuit. The display panel typically includes a display substrate and an opposite substrate arranged opposite to each other, sealing frame adhesives adhered between the opposite substrate and the display substrate, and liquid crystal charged in a cell structure formed by the opposite substrate, the display substrate and the sealing frame adhesives. The driving circuit includes a gate driving circuit and a source driving circuit. The gate driving circuit includes a clock module and a gate driving module. At present, the gate driving circuit is typically made on the opposite substrate to simplify the process of manufacturing the display device and to reduce the production cost.

The gate driving circuit transmits a gate driving signal by pull-up driving a transistor (the pull-up, in comparison with pull-down, refers to an input current of a device while the pull-down refers to an output current of the device). The gate driving signal is applied successively to respective gate lines under control of a clock signal, so as to switch on TFTs row by row.

### SUMMARY

An embodiment of the present disclosure provides a display substrate including: a base substrate and a black matrix formed on the base substrate, the black matrix having physical portions and a first gap region between the physical portions, the first gap region being aligned with a clock signal line of a gate driving circuit on an opposite substrate, wherein at least one layer of first color resist is provided in the first gap region.

In an embodiment, the first color resist is made from electrically insulating material.

In an embodiment, only one layer of first color resist is provided in the first gap region.

In an embodiment, the first color resist is a red color resist, a green color resist, a blue color resist, a yellow color resist, a white color resist, a cyan color resist or a black color resist.

In an embodiment, at least two layers of first color resist are provided in the first gap region.

In an embodiment, the at least two layers of first color resist include a layer of red color resist and a layer of green color resist stacked; or the at least two layers of first color resist include a layer of red color resist and a layer of blue color resist stacked; or the at least two layers of first color resist include a layer of green color resist and a layer of blue color resist stacked.

In an embodiment, the at least two layers of first color resist include a layer of red color resist, a layer of green color resist and a layer of blue color resist stacked.

In an embodiment, the black matrix further has a second gap region aligned with a pixel unit on the opposite substrate, a second color resist being formed in the second gap region.

In an embodiment, the first color resist and the second color resist which have a same color are formed by one patterning process.

In an embodiment, the physical portions of the black matrix are made from metal or metal oxide.

An embodiment of the present disclosure also provides a display panel including the display substrate according to any one of the above technical solutions and an opposite substrate arranged in opposite to the display substrate, wherein a gate driving circuit is provided on the opposite substrate and has a clock signal line.

An embodiment of the present disclosure also provides a display device including the display panel as described in the above technical solution.

An embodiment of the present disclosure also provides a method for producing a display substrate, the method including:

forming a black matrix on a base substrate and forming a first gap region at an area aligned with a clock signal line of a gate driving circuit on an opposite substrate, on the black matrix; and

forming at least one layer of first color resist at the first gap region of the black matrix.

In an embodiment, the method further includes:

forming a second gap region at an area aligned with a pixel unit on the opposite substrate, on the black matrix; and

forming a second color resist at the second gap region of the black matrix.

In an embodiment, the first color resist and the second color resist which have a same color are formed by one patterning process.

### BRIEF DESCRIPTION OF THE DRAWINGS

FIG. 1 is a schematic view showing a structure of a display panel in cross section according to an embodiment of the present disclosure;

FIG. 2 is a schematic view showing a structure of a display panel in cross section according to another embodiment of the present disclosure;

FIG. 3 is a schematic view showing a structure of a display panel in cross section according to a further embodiment of the present disclosure;

FIG. 4 is a flow chart of a method for producing a display substrate according to a further embodiment of the present disclosure; and

FIG. 5 is another flow chart of a method for producing a display substrate according to a further embodiment of the present disclosure.

### DETAILED DESCRIPTION

In order to reduce horizontal transverse striation effects in image display of the display device to improve display quality, embodiments of the present disclosure provide a display substrate, a display panel, a display device and a method for producing the display substrate. The exemplified embodiments of the present disclosure will below be explained in detail such that objects, technical solutions and advantages of the present disclosure become more explicit.

In accordance with a general inventive concept, an embodiment of the present disclosure provides a display substrate including: a base substrate and a black matrix formed on the base substrate, the black matrix having physical portions and a first gap region between the physical portions, the first gap region being aligned with a clock signal line of a gate driving circuit on an opposite substrate, wherein at least one layer of first color resist is provided in the first gap region.

In addition, in the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

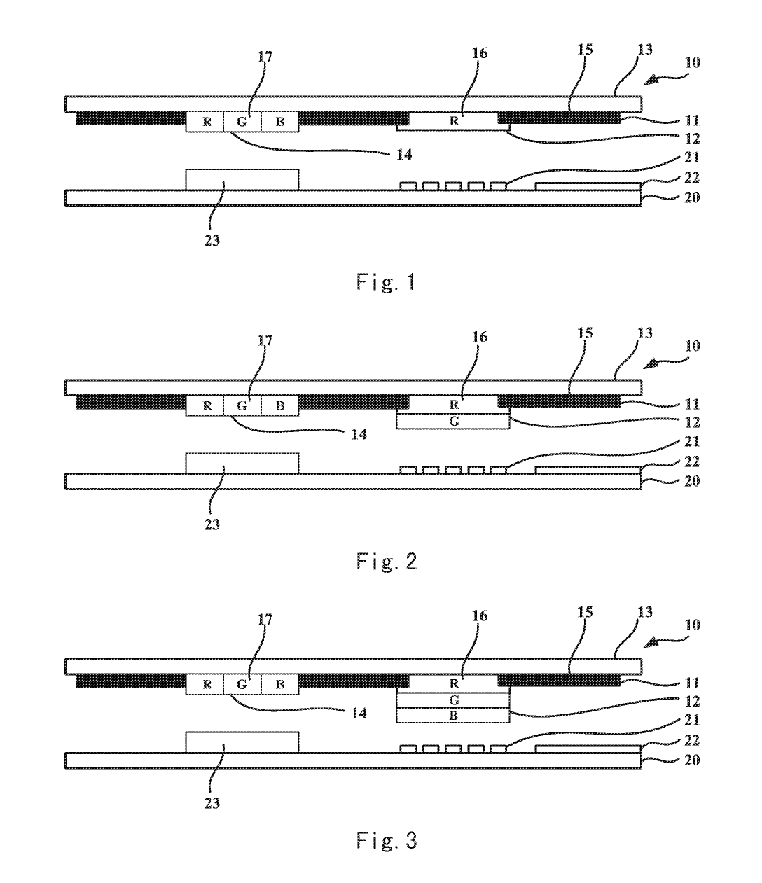

As illustrated in FIG. 1, the display substrate 10 provided by the embodiment of the present disclosure includes a base substrate 13 and a black matrix 11 formed on the base substrate 13. The black matrix 11 has physical portions 15 and a first gap region 16 between the physical portions 15. The first gap region 16 is aligned with a clock signal line 21 of a gate driving circuit on an opposite substrate 20. At least one layer of first color resist 12 is provided in the first gap region 16.

Such arrangement in which the first color resist 12 on the display substrate is aligned with the clock signal line may avoid electrode effects produced with the clock signal line, to prevent the clock signal from having excessive loads, so as to reduce difference among respective clock signals. It may prevent the horizontal traverse striation effects that occur when the display device displays images from degrading display quality. The first color resist 12 may for example be made from electrically insulating material. As an example, the physical portions of the black matrix 11 are made from conductive materials. The first color resist 12 provided between the physical portions of the black matrix 11 may reduce or eliminate the effects of the black matrix 11 on the clock signal line 21.

In an example, the first color resist 12 may include such as a red color resist, a green color resist, a blue color resist, a yellow color resist, a white color resist, a cyan color resist or a black color resist. The first color resist 12 may be made from resin insulation material. Number of clock signal lines of the gate driving circuit is determined depending on type of the display device and it is not limited to any specific values. For example, five clock signal lines are shown. It should be noted that, in the field of liquid crystal display, the color resist is not limited to RGB (red, green, blue) three colors, alternatively, it may a combination of multiple colors such as RGBW (red, green, blue, white), RGBY (red, green, blue, yellow) and CMYK (cyan, magenta, yellow, black).

In the technical solution of present disclosure, the first gap region is arranged in the area, which is aligned with the clock signal line 21 of the gate driving circuit on the opposite substrate, on the black matrix 11 and the first color resist 12 is provided in the first gap region. Thus, in comparison with the prior art, it may reduce load of the clock signal to reduce the horizontal traverse striation effects in image display of the display device to improve display quality as the first color resist 12 has good insulation.

Use of the first color resist 12 as an insulation portion aligned with the clock signal line 21 of the gate driving circuit on the opposite substrate 20, not only may reduce load of the clock signal, but also may shield stray light to some extent.

In an embodiment of the present disclosure, the physical portions of the black matrix may be made from metal or meal oxide, for example, chromium or chromium oxide. The black matrix has a main effect of shielding stray light by physical portions to prevent light from being leaked between a pixel unit and a part corresponding to the pixel unit to degrade the display effect.

As shown in FIG. 1 again, in an embodiment of the present disclosure, only one layer of first color resist 12 is provided in the first gap region. By means of this technical solution, the first color resist 12 may be formed by a single patterning process, to simplify the process of producing the display substrate and to save the producing cost. The color of the first color resist 12 is not limited to any colors, for example, the first color resist may be any one of such as red color resist, green color resist or blue color resist. As an example, it is shown as the red color resist in Figure (indicated by R).

In another embodiment of the present disclosure, at least two layers of first color resist 12 are provided in the first gap region 16. With such technical solution, the at least two layers of first color resist 12 may further reduce the load of the clock signal. The at least two layers of first color resist 12 may also enhance the effect of shielding the stray light.

As illustrated in FIG. 2, when two layers of first color resist 12 are provided in the first gap region 16, the at least two layers of first color resist 12 may include a layer of red color resist and a layer of green color resist stacked; or the two layers of first color resist 12 may include a layer of red color resist and a layer of blue color resist stacked; or the two layers of first color resist 12 may include a layer of green color resist and a layer of blue color resist stacked. The layer of red color resist (indicated by R) and the layer of green color resist (indicated by G) stacked are shown in Figure. However, embodiments of the present disclosure are not limited to this. For example, other color resists such as yellow color resist, white color resist, cyan color resist or black color resist may also be combined with each other or with the above color resist.

As shown in FIG. 3, as an example, when three layers of first color resist 12 are provided in the first gap region 16, the three layers of first color resist 12 may include a layer of red color resist, a layer of green color resist and a layer of blue color resist stacked.

In an example, the black matrix 11 may further have a second gap region 17 aligned with a pixel unit 23 on the opposite substrate 20, a second color resist 14 being formed in the second gap region 17. The second color resist 14 may for example filter color of light emitted from the pixel unit 23, so as to produce the light with desired color, for example to form corresponding sub-pixels. The second color resist 14 for example may also include such as a red color resist, a green color resist, a blue color resist, a yellow color resist, a white color resist, a cyan color resist or a black color resist.

As an example, the first color resist 12 and the second color resist 14 with a same color may be formed by one patterning process. In case that the pixel unit 23 needs the second color resist 14 to filter color, use of the first color resist 12 as an insulation portion aligned with the clock signal line 21 of the gate driving circuit on the opposite substrate 20 may prevent the process of producing the substrate from being complicated. The first color resist 12 and the second color resist 14 with the same color may be formed together in patterning process, without any additional process or materials. The first color resist 12 and the second color resist 14 with the same color may also have the same material.

As shown in FIG. 1 to FIG. 3, an embodiment of the present disclosure also provides a display panel including the display substrate 10 as described in any of the above embodiments and an opposite substrate 20 arranged in opposite to the display substrate 10. A gate driving circuit is provided on the opposite substrate and has a clock signal line 21. The display panel may reduce the horizontal traverse striation effects in display to improve the display quality.

An embodiment of the present disclosure also provides a display device including the display panel as described above. The gate driving circuit having the clock signal line 21 is provided on the opposite substrate. As illustrated in FIG. 1 to FIG. 3, the clock signal line 21 and the driving transistor 22 of the gate driving circuit are provided on the opposite substrate. The display device may reduce the horizontal traverse striation effects in display to improve display quality.

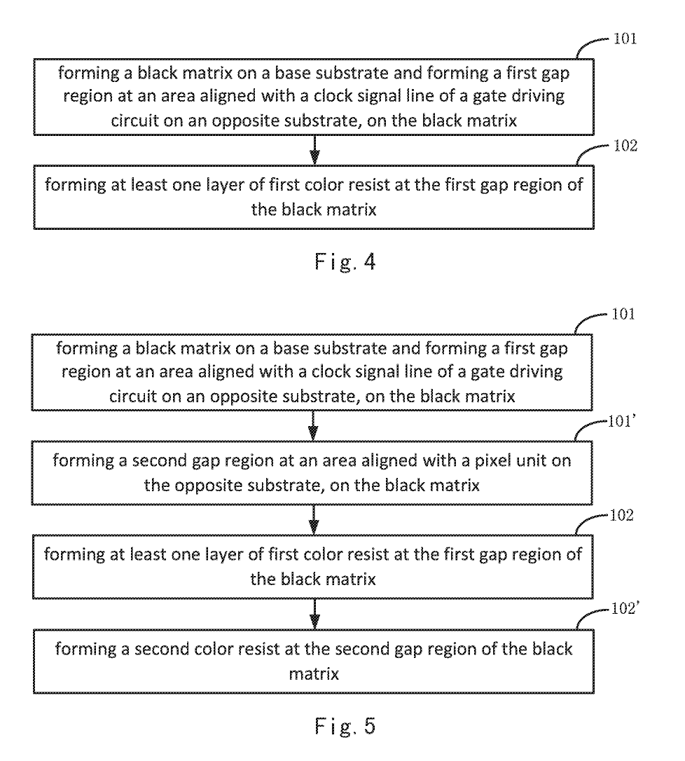

As illustrated in FIG. 4, an embodiment of the present disclosure also provides a method for producing a display substrate, the method including:

Step 101: forming a black matrix on a base substrate and forming a first gap region at an area aligned with a clock signal line of a gate driving circuit on an opposite substrate, on the black matrix; and

Step 102: forming at least one layer of first color resist at the first gap region of the black matrix.

By means of the method provided by the embodiment of the present disclosure, the first gap region is provided in the area, which is aligned with the clock signal line of the gate driving circuit on the opposite substrate, on the black matrix and the first color resist is formed in the first gap region. In comparison with the prior art, as the first color resist has good insulation, the load of the clock signal may be reduced to suppress the horizontal traverse striation effects in image display of the display device, so as to improve display quality.

In an embodiment, as shown in FIG. 5, the above method may further include:

Step 101′: forming a second gap region at an area aligned with a pixel unit on the opposite substrate, on the black matrix; and

Step 102′: forming a second color resist at the second gap region of the black matrix.

As an example, the Step 101′ and the Step 101 may be implemented in the same step. That is, the second gap region and the first gap region may be formed together in patterning process. As such, the Step 102′ and the Step 102 may be implemented in the same step. That is, the second color resist and the first color resist may be formed together in one patterning process. However, embodiments of the present disclosure are not limited to this, for example, the Step 101′ and the Step 101 and/or the Step 102′ and the Step 102 may also be implemented in different steps, e.g., implemented in order shown in FIG. 5.

In an example, the first color resist 12 and the second color resist 14 with the same color may be formed by one patterning process. Use of the technical solution may simplify the process of producing the display substrate to save the producing time and producing cost.

In an example, the second color resist 14 has a main function of producing red green blue three-primary colors by filtering and mixing the three-primary colors in different intensity ratio, to produce various colors such that a thin film transistor liquid crystal display screen can display full color. It should be noted that, in the field of liquid crystal display, the second color resist 14 is not limited to RGB (red, green, blue) three colors shown in FIG. 1, alternatively, it may a combination of multiple colors such as RGBW (red, green, blue, white), RGBY (red, green, blue, yellow) and CMYK (cyan, magenta, yellow, black).

It should be noted that the terms of “first” and “second” in the present disclosure are only intended to distinguish different modified objects from each other, without representing the order.

Although the present disclosure has been explained with reference to the drawings, the embodiments shown in the drawings are only illustrative, instead of limiting the present disclosure. Scales shown in Figures are only illustrative, instead of limiting the present disclosure.

Only some exemplified embodiments of the present disclosure are explained in the above description. However, the skilled person in the art can made various modifications and alternations on the present disclosure without departing from the principles and spirit of the present disclosure. Thus, these modifications and alternations are intended to be contained in the present disclosure if those fall within the scope of claims and their equivalents of the present disclosure.

1. A display substrate comprising:
a base substrate and a black matrix formed on the base substrate, the black matrix having physical portions and a first gap region between the physical portions, the first gap region being aligned with a clock signal line of a gate driving circuit on an opposite substrate, wherein at least one layer of first color resist is provided in the first gap region.

2. The display substrate according to claim 1, wherein the first color resist is made from electrically insulating material.

3. The display substrate according to claim 1, wherein only one layer of first color resist is provided in the first gap region.

4. The display substrate according to claim 3, wherein the first color resist is a red color resist, a green color resist, a blue color resist, a yellow color resist, a white color resist, a cyan color resist or a black color resist.

5. The display substrate according to claim 1, wherein at least two layers of first color resist are provided in the first gap region.

6. The display substrate according to claim 5, wherein the at least two layers of first color resist comprise a layer of red color resist and a layer of green color resist stacked; or the at least two layers of first color resist comprise a layer of red color resist and a layer of blue color resist stacked; or the at least two layers of first color resist comprise a layer of green color resist and a layer of blue color resist stacked.

7. The display substrate according to claim 5, wherein the at least two layers of first color resist comprise a layer of red color resist, a layer of green color resist and a layer of blue color resist stacked.

8. The display substrate according to claim 1, wherein the black matrix further has a second gap region aligned with a pixel unit on the opposite substrate, a second color resist being formed in the second gap region.

9. The display substrate according to claim 8, wherein the first color resist and the second color resist which have a same color are formed by one patterning process.

10. The display substrate according to claim 1, wherein the physical portions of the black matrix are made from metal or metal oxide.

11. A display panel comprising the display substrate according to claim 1 and an opposite substrate arranged opposite to the display substrate, wherein a gate driving circuit is provided on the opposite substrate and has a clock signal line.

12. A display device comprising the display panel according to claim 11.

13. A method for producing a display substrate, the method comprising:
forming a black matrix on a base substrate and forming a first gap region on the black matrix at an area aligned with a clock signal line of a gate driving circuit on an opposite substrate; and
forming at least one layer of first color resist at the first gap region of the black matrix.

14. The method according to claim 13, further comprising:
forming a second gap region on the black matrix at an area aligned with a pixel unit on the opposite substrate; and
forming a second color resist at the second gap region of the black matrix.

15. The method according to claim 14, wherein the first color resist and the second color resist have a same color and are formed by one patterning process.

16. The display panel according to claim 11, wherein the first color resist is made from electrically insulating material.

17. The display panel according to claim 11, wherein only one layer of the first color resist is provided in the first gap region.

18. The display panel according to claim 17, wherein the first color resist is a red color resist, a green color resist, a blue color resist, a yellow color resist, a white color resist, a cyan color resist or a black color resist.

19. The display panel according to claim 11, wherein at least two layers of first color resist are provided in the first gap region.

20. The display panel according to claim 19, wherein the at least two layers of first color resist comprise a layer of red color resist and a layer of green color resist stacked; or the at least two layers of first color resist comprise a layer of red color resist and a layer of blur color resist stacked; or the at least two layers of first color resist comprise a layer of green color resist and a layer of blue color resist stacked.
